(19) United States
(12) Patent Application Publication
(10) Pub. No.: US 2007/0187302 A1
(43) Pub. Date: Aug. 16, 2007

(54) Dewatering of aqueous magnetite concentrates

(75) Inventor: Fernando Parra Huerta, Santiago (CL)

Correspondence Address: BUCHANAN, INGERSOLL & ROONEY PC, POST OFFICE BOX 1404, ALEXANDRIA, VA, 22313-1404, US

(73) Assignees: Magnapower (Proprietary) Limited, Gauteng (ZA); Multotec Process Equipment (Pty) Ltd., Gauteng (ZA)

(21) Appl. No.: 11/524,311

(22) Filed: Sep. 21, 2006

(30) Foreign Application Priority Data
Sep. 22, 2005 (ZA) 2005/07668

(51) Int. Cl. B03C 1/00; C02F 1/48; B03C 1/02; B01D 35/06; B03C 1/30

(52) U.S. Cl. 209/223.2; 210/222

(57) ABSTRACT

One aspect of the invention concerns a method of dewatering an aqueous magnetite slurry concentrate. In the method, the concentrate (78) is deposited on an external surface of a rotating drum (16) in which is located a stationary, permanent magnet (32) so that magnetite in the concentrate is attracted onto the surface of the drum by the magnet. The intensity of the magnet is sufficient to cause the magnetite to form on the drum surface a compacted cake from which water is displaced. The cake is then removed from the drum surface after it has passed the magnet. Other aspects of the invention concern the apparatus used in the method as well as the combination of the dewatering method and apparatus with a method and apparatus for concentrating an initial magnetite slurry feed.

### BACKGROUND TO THE INVENTION

THIS invention relates to the dewatering of magnetite concentrates produced by wet magnetic separation.

Wet magnetic separation processes to produce magnetite concentrations are well known. In a typical process a slurry of magnetite and water is fed into a vessel in which a drum, typically of non-magnetic material, rotates about a horizontal axis. The feed rate and drum position are such that a lower part of the drum circumference passes through slurry at the bottom of the vessel. A fixed, low intensity magnet, typically a ceramic magnet, is located at a low position in the drum. The magnetic component of the slurry, i.e. magnetite, is attracted by the magnet and attaches itself to the rotating drum surface adjacent the magnet. At a downstream point where the magnet ends, the magnetic material tends to accumulate. The accumulation of the material eventually causes it to detach itself from the drum surface and it fails onto a chute which conveys it to a concentrate collector. Water and other non-magnetic slurry components are not attracted onto the drum surface and overflow from the vessel.

Typically, the magnetite concentrate which is produced by a process such as that outlined above has a water content in the region of 40% by weight. However, for stockpiling, pelletisation or bulk transportation, the water content should not exceed 10%. To reduce the water content to an acceptable level, conventional practice is to subject the concentrate to a dewatering step using, for instance, drum or belt filters or filter presses. However the necessity for such dewatering apparatus considerably increases the cost of the overall magnetite recovery operation.

The present invention seeks to provide an alternative method and apparatus for dewatering the aqueous magnetite concentrate.

### SUMMARY OF THE INVENTION

According to one aspect of the present invention there is provided a method of dewatering an aqueous magnetite slurry concentrate, typically one produced by a wet magnetic separator, the method including the steps of:
depositing the concentrate on the surface of a rotating drum in which is located a stationary, permanent magnet, such that magnetite in the concentrate is attracted onto the surface of the drum by the magnet, the intensity of the magnet being sufficient to cause the magnetite to form a compacted cake on the said surface from which water is displaced; and
removing the magnetite-rich cake from the said surface after it has passed the magnet.

In the preferred method, the permanent magnet is a rare earth magnet which produces a magnetic field strength of at least 7×10³ Gauss (7×10⁻¹ Tesla), typically an NIB (neodymium iron boron) magnet. The permanent magnet may be an NIB magnet.

Preferably the aqueous concentrate is deposited on an upper part of the external surface of the rotating drum. Typically the magnet will extend about a lower part of the drum circumference from an upstream end adjacent an upper part of the rotating drum, and the aqueous concentrate is deposited on the external surface of the rotating drum at a position adjacent the upstream end of the magnet. This may be achieved via a chute which extends in a curve around the external surface of the drum.

Magnetite-rich cake may be removed from the external surface of the drum, at a position beyond a downstream end of the magnet, by a scraper.

The method is preferably operated in such a manner as to produce a dewatered, magnetite-rich cake having a water content not exceeding 10% by weight.

Further according to the invention there is provided apparatus for dewatering an aqueous magnetite slurry concentrate, the apparatus comprising:
a rotatable drum;
means for rotating the drum about a horizontal axis;
a permanent magnet located inside the drum close to a wall of the drum;
delivery means for depositing the aqueous concentrate onto the external surface of the drum such that magnetite in the concentrate is attracted onto the drum surface by the magnet, the intensity of the magnet being sufficient to cause the magnetite to form a compacted cake on the drum surface from which water is displaced; and
means for removing the magnetite-rich cake from the drum surface after the cake has passed the magnet.

The apparatus may be arranged to dewater a magnetite slurry concentrate produced by a wet magnetic separator.

In the preferred embodiment the magnet extends, over an arc of at least 180°, about a lower part of the drum circumference from an upstream end adjacent an upper part of the rotating drum and the delivery means includes a chute which extends in a curve around the external surface of the drum. The chute is conveniently arranged to hold the aqueous magnetite concentrate in contact with the drum surface over an arc extending from an open upstream end of the chute to an open downstream end thereof.

For this purpose the chute may have a bottom, a top and side walls, the top and side walls extending from the upstream end of the chute to the downstream end thereof but the bottom extending for a relatively short distance only from the upstream end of the chute to a position adjacent an upper part of the drum surface. Typically the chute extends through an arc of about 135°.

The invention also extends to a method of concentrating and dewatering a magnetite slurry, the method comprising the steps of subjecting the slurry to a wet magnetic separation process to produce an aqueous magnetite concentrate, and thereafter dewatering the concentrate using the method summarised above, preferably such that the dewatered concentrate has a water content not exceeding 10% by weight.

Still further, the invention extends to apparatus for concentrating and dewatering a magnetite slurry, comprising a wet magnetic separator to which the slurry is fed and which is operable to produce an aqueous magnetite concentration, and a dewatering apparatus, as summarised above, operable to dewater the concentrate preferably such that the dewatered produced has a water content not exceeding 10% by weight.

### BRIEF DESCRIPTION OF THE DRAWING

The invention will now be described in more detail, by way of example only, with reference to the accompanying drawings in which:

FIG. 1 diagrammatically illustrates a dewatering method and apparatus according to the invention; and

FIG. 2 diagrammatically illustrates a magnetite concentration and dewatering method and apparatus according to the invention.

### DESCRIPTION OF PREFERRED EMBODIMENTS

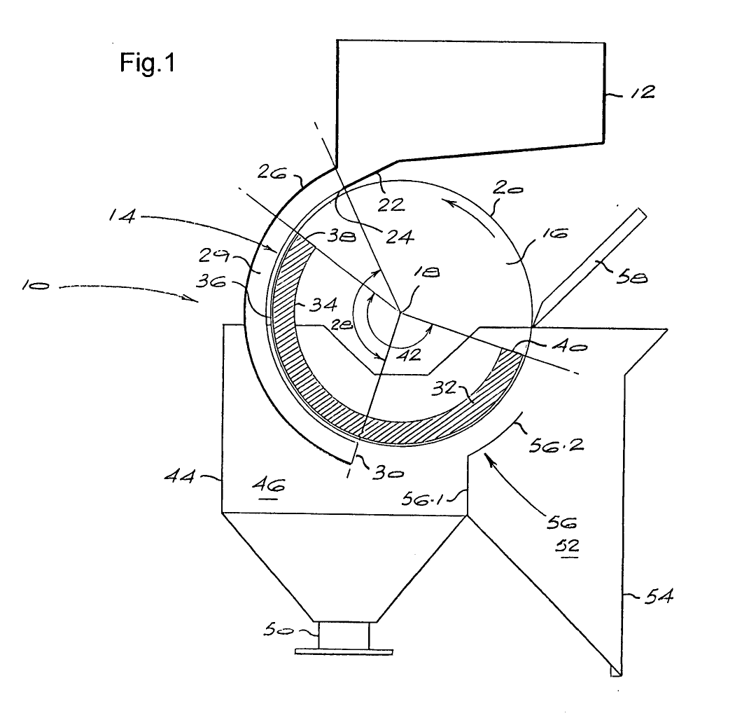

FIG. 1 shows a dewatering apparatus 10 according to the invention. The apparatus 10 includes a feed hopper 12 which receives a magnetite slurry which is to be concentrated and dewatered. The magnetite slurry may, for instance, be derived from mining operations or it may be a slurry of magnetite which is to be recovered for re-use in a DMS (dense medium separation) process.

The hopper discharges into a curved chute 14 extending a substantial distance about the circumference of a hollow drum 16 which is rotated about its central axis 18. The drum wall 20 is made of a non-magnetic material. The bottom 22 of the chute 14, i.e. the radially inner wall thereof, terminates at a point 24 near to the top of the drum. It will accordingly be understood that only a short, upstream portion of the chute has a bottom and that, over the remainder of the chute, it has no bottom and is inwardly open to the drum The chute also has a top or radially outer wall 26 which extends for a full extent of the chute, through an arc 28 of about 135°, and side walls 29 (only one visible) extending for the full extent of the chute. The donwnstream end 30 of the chute is open.

Located inside the drum 16 is a curved, stationary, high intensity NIB magnet assembly 32 having a radially inner surface 34 and a radially outer surface 36 positioned close to the drum wall 20. The NIB magnet assembly produces a magnetic field intensity at the surface of the drum wall of at least 7×10³ Gauss (7×10⁻¹ Tesla), and preferably of about 8×10³ Gauss (8×10⁻¹ Tesla).

The magnet assembly commences at an upstream end 38 in an upper part of the drum circumference, slightly downstream of the point 24, and terminates at a downstream end 40. Between the upstream and downstream ends, the magnet assembly extends over an arc 42 of about 200°.

The lower part of the drum wall passes through a container 44. An upstream portion of the container 44 is formed as a chute 46 leading to an outlet 50. A downstream part of the container is formed as a chute 52 leading to an outlet 54. Between the chutes 46 and 52 is a divider 56 composed of a planar, vertical wall 56.1 and a curved wall 56.2.

The apparatus 10 seen in FIG. 1 also includes a scraper 58 positioned close to the external surface of the drum wall 20, just downstream of the end 40 of the magnet assembly 32.

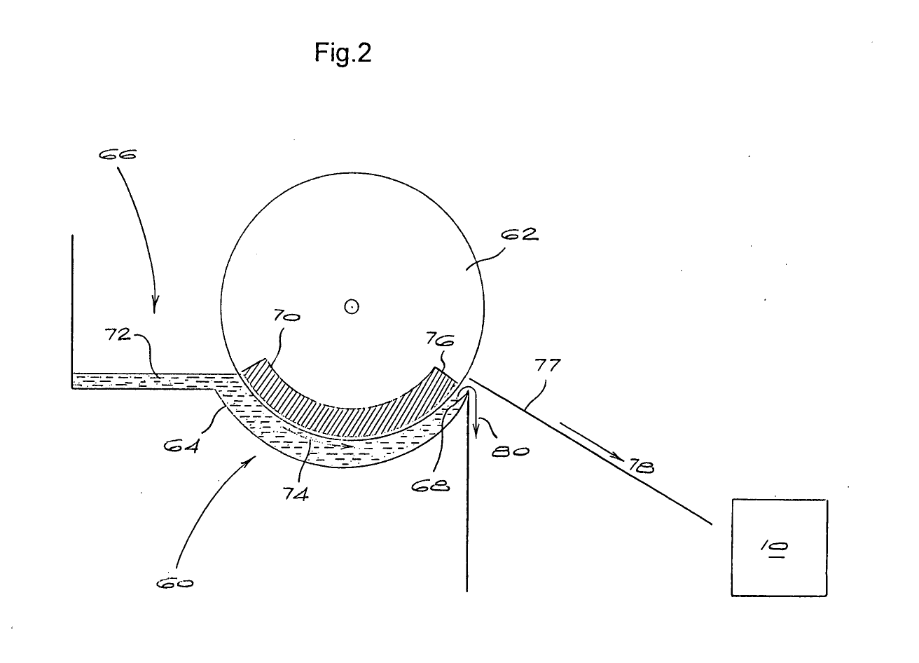

In FIG. 2, the apparatus described above is represented diagrammatically by the numeral 10. The FIG. 2 apparatus includes, in addition to the apparatus 10, a magnetite concentration apparatus 60. This includes a rotating drum 62, a lower part of which passes through a vessel 64 having an upstream feed opening 66 and a weir 68 at its downstream end. Located inside the drum, the wall of which is made of a non-magnetic material, is a relatively low intensity, stationary, permanent magnet assembly 70. The magnetic field intensity produced by the magnet assembly 70, which may be an assembly of ceramic magnets, is typically of the order of 1.5×10³ Gauss (1.5×10⁻¹ Tesla).

A magnetite slurry 72 which is to be concentrated is introduced into the vessel 64 through the feed opening 66. Magnetic components of the feed slurry, i.e. magnetite particles, are attracted onto the drum wall in the vicinity of the magnet 70. The drum wall carries the material in the anticlockwise direction indicated by the arrow 74. At the point 76 where the magnet ends, the material tends to accumulate and eventually falls off the drum wall onto a chute 77 which removes it as indicated by the arrow 78.

Other non-magnetic components of the initial feed slurry are not attracted onto the wall of the drum and accumulate in the vessel 64 for eventual displacement over the weir 68 as indicated by the arrow 80.

The material indicated by the arrow 78 is in the form of an aqueous magnetite slurry, typically having a water content of about 40% by weight. As explained previously, it is desirable to dewater this slurry, preferably to a water content not exceeding 10% by weight so that the material can be stockpiled, pelletised or transported.

Dewatering of the aqueous magnetite slurry 78 is carried out by the apparatus 10. The slurry is introduced into the hopper 12 which delivers it onto the wall of the drum 16 via the chute 14. The high intensity magnet assembly 32 generates an intense magnetic field which strongly attracts the magnetic component of the slurry, i.e. the magnetite, onto the external surface of the drum wall. The very strong attraction which is achieved causes the magnetite to form a compacted cake on the drum surface. The water content of the slurry is largely displaced by the solid material in the cake. It can be said that the water is “squeezed” out of the cake by the strong magnetic attraction. The displaced water as well as free water and other non-magnetic material drops into the chute 46 from which it discharges via the outlet 50.

The caked magnetite is carried around by the drum wall to the end of the magnet assembly, where the magnetic attraction force terminates, allowing the caked material to be scraped from the drum surface by the scraper 58. The dewatered material drops into the chute 52 from which it can be recovered through the outlet 54.

It will be noted that the magnet assembly 32 extends in a substantial arc, greater than 1800 in angular extent. This allows the intense magnet field to compact progressively more and more magnetic material, i.e. magnetite, into the cake which forms on the drum surface with increasing expulsion of the water content. Water which is driven out of the cake towards the end of the magnet assembly falls onto the curved divider wall 56.2 which directs it back into the chute 46 for discharge through the outlet 50. Substantially only dewatered magnetite falls into the chute 52.

In initial experimentation it has been found that it is possible, using the dewatering apparatus 10, to reduce the water content of the magnetite slurry to less than 10% by weight.

I claim:

1. A method of dewatering an aqueous magnetite slurry concentrate, the method including the steps of:
depositing the concentrate on an external surface of a rotating drum in which is located a stationary, permanent magnet, such that magnetite in the concentrate is attracted onto the surface of the drum by the magnet, the intensity of the magnet being sufficient to cause the magnetite to form on the said surface a compacted cake from which water is displaced; and
removing the magnetite-rich cake from the said surface after it has passed the magnet.

2. A method according to claim 1 wherein the magnetite slurry concentrate is produced by a wet magnetic separator.

3. A method according to claim 1 wherein the permanent magnet is a rare earth magnet which produces a magnetic field strength of at least 7×10³ Gauss (7×10⁻¹ Tesla).

4. A method according to claim 3 wherein the permanent magnet is an NIB magnet.

5. A method according to claim 1 wherein the aqueous concentrate is deposited on an upper part of the external surface of the rotating drum.

6. A method according to claim 5 wherein the magnet extends about a lower part of the drum circumference from an upstream end adjacent an upper part of the rotating drum, and the aqueous concentrate is deposited on the external surface of the rotating drum at a position adjacent the upstream end of the magnet.

7. A method according to claim 6 wherein the aqueous concentrate is deposited on the external surface of the drum via a chute which extends in a curve around the external surface of the drum.

8. A method according to claim 7 wherein magnetite-rich cake is removed from the external surface of the drum, at a position beyond a downstream end of the magnet, by a scraper.

9. A method according to claim 8 wherein the magnetite rich cake removed from the external surface of the drum has a water content of less than 10% by weight.

10. Apparatus for dewatering an aqueous magnetite slurry concentrate, the apparatus comprising:
a rotatable drum;
means for rotating the drum about a horizontal axis;
a permanent magnet located inside the drum close to a wall of the drum;
delivery means for depositing the aqueous concentrate onto the external surface of the drum such that magnetite in the concentrate is attracted onto the drum surface by the magnet, the intensity of the magnet being sufficient to cause the magnetite to form a compacted cake on the drum surface from which water is displaced; and
means for removing the magnetite-rich cake from the drum surface after the cake has passed the magnet.

11. Apparatus according to claim 10, wherein the apparatus is arranged to dewater a magnetite slurry concentrate produced by a wet magnetic separator.

12. Apparatus according to claim 10 wherein the permanent magnet is a rare earth magnet which produces a magnetic field strength of at least 7×10³ Gauss (7×10⁻¹ Tesla).

13. Apparatus according to claim 12 wherein the permanent magnet is an NIB magnet.

14. Apparatus according to claim 10 wherein the magnet extends, over an arc of at least 180°, about a lower part of the drum circumference from an upstream end adjacent an upper part of the rotating drum.

15. Apparatus according to claim 14 wherein the delivery means comprises a chute which extends in a curve around the external surface of the drum.

16. Apparatus according to claim 15 wherein the chute is arranged to hold the aqueous magnetite concentrate in contact with the drum surface over an arc extending from an open upstream end of the chute to an open downstream end thereof.

17. Apparatus according to claim 16 wherein the chute has a bottom, a top and side walls, the top and side walls extending from the upstream end of the chute to the downstream end thereof but the bottom extending for a relatively short distance only from the upstream end of the chute to a position adjacent an upper part of the drum surface.

18. Apparatus according to claim 15 wherein the chute extends through an arc of about 135°.

19. Apparatus according to claim 10 comprising a scraper arranged to scrape magnetite-rich cake from the external surface of the drum at a position beyond a downstream end of the magnet.

20. A method of concentrating and dewatering a magnetite slurry, the method comprising the steps of subjecting the slurry to a wet magnetic separation process to produce an aqueous magnetite concentrate and thereafter dewatering the concentrate by:
depositing the concentrate on an external surface of a rotating drum in which is located a stationary, permanent magnet, such that magnetite in the concentrate is attracted onto the surface of the drum by the magnet, the intensity of the magnet being sufficient to cause the magnetite to form on the said surface a compacted cake from which water is displaced; and
removing the magnetite-rich cake from the said surface after it has passed the magnet.

21. Apparatus for concentrating and dewatering a magnetite slurry, the apparatus comprising a wet magnetic separator into which the slurry is introduced in use and which is operable to produce an aqueous magnetite concentrate, and a dewatering apparatus arranged to receive the concentrate and dewater it, the dewatering apparatus including:
a rotatable drum;
means for rotating the drum about a horizontal axis;
a permanent magnet located inside the drum close to a wall of the drum;
delivery means for depositing the aqueous concentrate onto the external surface of the drum such that magnetite in the concentrate is attracted onto the drum surface by the magnet, the intensity of the magnet being sufficient to cause the magnetite to form a compacted cake on the drum surface from which water is displaced; and
means for removing the magnetite-rich cake from the drum surface after the cake has passed the magnet.
